(19) United States
(12) Patent Application Publication
(10) Pub. No.: US 2018/0122598 A1
(43) Pub. Date: May 3, 2018

(54) FILTERS FOR SELECTING ALPHABET OF CHARACTERS PRESENTED BY KEYBOARD

(71) Applicant: Google LLC, Mountain View, CA (US)

(72) Inventors: Alexander Friedrich Kuscher, San Francisco, CA (US); Omri Amarilio, Palo Alto, CA (US); Katie Leah Roberts-Hoffman, San Jose, CA (US)

(21) Appl. No.: 15/791,998

(22) Filed: Oct. 24, 2017

Related U.S. Application Data
(60) Provisional application No. 62/415,160, filed on Oct. 31, 2016.

(51) Int. Cl. H01H 13/83; G06F 3/023; G06F 3/02

(52) U.S. Cl. CPC H01H 13/83; G06F 3/0238; H01H 2219/014; H01H 2219/054; G06F 3/0219

(57) ABSTRACT

A computing system may include a keyboard and at least one backlight. The keyboard may include at least one key. The at least one key may include a first filter shaped according to a first character in a first alphabet. The first filter may transmit light within a first spectral range. The at least one key may also include a second filter shaped according to a second character in a second alphabet. The second filter may transmit light within a second spectral range. The at least one backlight may be configured to shine light of a first wavelength within the first spectral range in response to an instruction to display the first alphabet, and shine light of a second wavelength within the second spectral range in response to an instruction to display the second alphabet.

### CROSS-REFERENCE TO RELATED APPLICATION

This application is a Nonprovisional of, and claims priority to, U.S. Patent Application No. 62/415,160, filed on Oct. 31, 2016, entitled “FILTERS FOR SELECTING ALPHABET OF CHARACTERS PRESENTED BY KEYBOARD”, which is incorporated by reference herein in its entirety.

### TECHNICAL FIELD

This description relates to keyboards for computing systems.

### BACKGROUND

Users may type characters into keyboards of computing systems. The keys in the keyboards may be associated with particular characters or symbols within an alphabet. Users may desire to type characters or symbols of different alphabets on a same keyboard.

### SUMMARY

According to an example, a computing system may include a keyboard and at least one backlight. The keyboard may include at least one key. The at least one key may include a first filter shaped according to a first character in a first alphabet. The first filter may transmit light within a first spectral range. The at least one key may also include a second filter shaped according to a second character in a second alphabet. The second filter may transmit light within a second spectral range. The at least one backlight may be configured to shine light of a first wavelength within the first spectral range in response to an instruction to display the first alphabet, and shine light of a second wavelength within the second spectral range in response to an instruction to display the second alphabet.

According to another example, a method may include receiving a selection of a first alphabet, based on the selection of the first alphabet, transmitting light within a first spectral range through a first filter within a key on a keyboard to display a first character, receiving a selection of a second alphabet, based on the selection of the second alphabet, stopping transmission of the light within the first spectral range, and transmitting light within a second spectral range through a second filter within the key on the keyboard to display a second character.

The details of one or more implementations are set forth in the accompanying drawings and the description below. Other features will be apparent from the description and drawings, and from the claims.

### BRIEF DESCRIPTION OF THE DRAWINGS

FIG. 1A is a diagram of a computing system according to an example embodiment.

FIG. 1B is a diagram of a computing system according to another example embodiment.

FIG. 2A is a top view of a key included in a keyboard of either of the computing systems of FIGS. 1A and 1B according to an example embodiment.

FIG. 2B is a top view of a key included in a keyboard of either of the computing systems of FIGS. 1A and 1B according to another example embodiment.

FIG. 3A shows a backlight transmitting light within a first spectral range through a first filter of the key of either FIG. 2A or FIG. 2B according to an example embodiment.

FIG. 3B shows a backlight transmitting light within a second spectral range through a second filter of the key of either FIG. 2A or FIG. 2B according to an example embodiment.

FIG. 4 is a diagram of the key in an example in which the backlight is included in the key.

FIG. 5 is a cross-sectional view of the keyboard in an example in which the backlight is disposed behind the keys.

FIG. 6 shows a display with a menu for selecting a language according to an example embodiment.

FIG. 7 is a flowchart showing a method according to an example embodiment.

FIG. 8 shows an example of a computer device and a mobile computer device that can be used to implement the techniques described here.

Like reference symbols in the various drawings indicate like elements.

### DETAILED DESCRIPTION

Keys on a keyboard may display characters or symbols of different alphabets by including filters with different spectral ranges shaped according to different characters. With respect to each key on the keyboard, a backlight may shine light within a first spectral range through the key, causing the key to present a first character for which a first filter that transmits light within the first spectral range is shaped. The backlight may shine light within a second spectral range through the key, causing the key to present a second character for which a second filter that transmits light within the second spectral range is shaped. A first alphabet may be associated with the first spectral range, and a second alphabet may be associated with the second spectral range. A user may select an alphabet, which may be based on a language, within which the keys will present characters or symbols. Based on which alphabet the user selected, the computing system may transmit light within the first spectral range through the keys to present characters within the first alphabet, or transmit light within the second spectral range through the keys to present characters within the second alphabet.

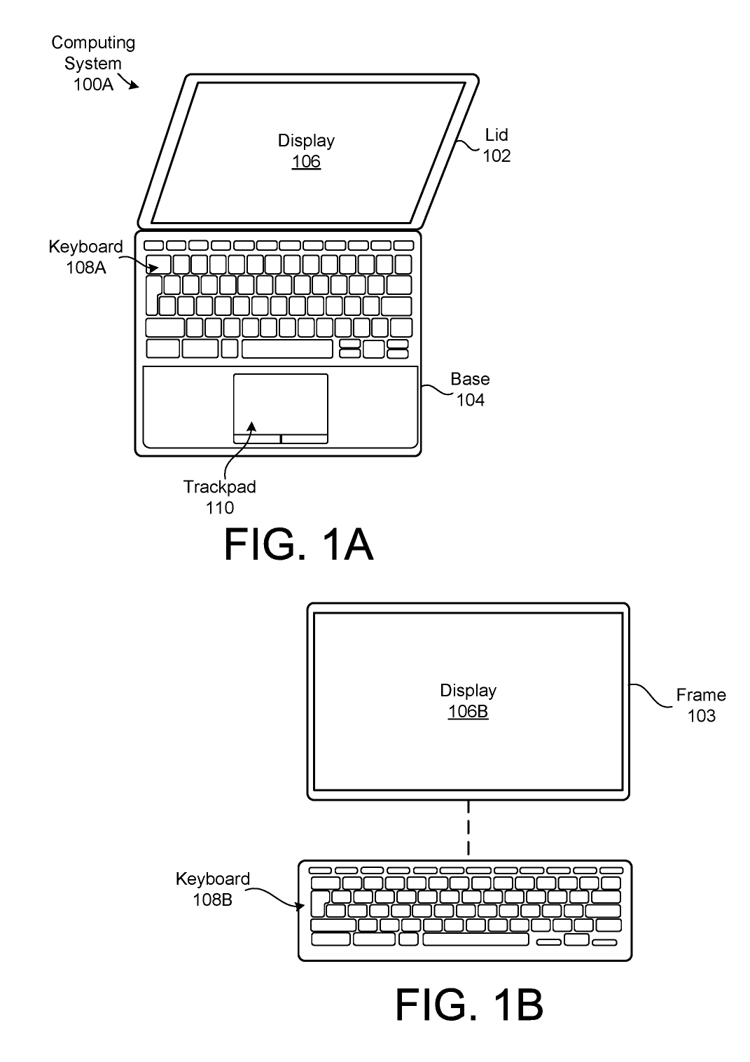

FIG. 1A is a diagram of a computing system 100A according to an example embodiment. In this computing system 100A, which may be considered a laptop computer or a notebook computer, a lid 102 may be rotatably connected to a base 104. The lid 102 may include a display 106A for presenting graphical output.

The base 104 may include a keyboard 108A for receiving character input (such as letters, numbers, and/or symbols inputted via keys on the keyboard 108A) and a trackpad 110 for receiving directional input. The keyboard 108A may include at least one key or multiple keys.

The keys on the keyboard 108A may collectively present or display characters or symbols within an alphabet. The alphabet may be considered a set of characters or symbols. The keyboard 108A may, at a first time, present or display characters or symbols within a first alphabet, and switch to presenting or displaying characters or symbols within a second alphabet at a second time. The presentation of characters or symbols within the first alphabet or second alphabet may be based on user selection of an alphabet or language. The keyboard 108A may be configured to display characters or symbols within two or more alphabets. The alphabets may be distinct and/or non-overlapping, with none of the characters or symbols in the first alphabet being included in the second alphabet and none of the characters or symbols in the second alphabet being included in the first alphabet, or the alphabets may overlap, with one or more characters in the first alphabet being included in the second alphabet. The alphabets may be associated with languages, and include letters, symbols, characters or words from the associated languages, such as English, Chinese, Hebrew, and/or Greek, and/or may be associated with symbols that are not included in traditional languages, such as emoticons including smiley faces ( [symbol] ) or frowns ( [symbol] ), as non-limiting examples.

The keys on the keyboard 108A may present characters from different alphabets by filtering different spectral ranges. The keys may, for example, include a first set of filters (which may include one and only one filter from the first set per key) with shapes of characters or symbols in a first alphabet that transmit light within a first spectral range that is in the visible light spectrum, and a second set of filters (which may include one and only one filter from the second set per key) with shapes of characters or symbols in a second alphabet that transmit light within a second spectral range that is within the visible light spectrum. To display the characters in the first alphabet, a backlight may transmit light within the first spectral range through the keys, causing the first set of filters to transmit light and the second set of filters to block light, displaying the characters or symbols in the first alphabet. To display the characters in the second alphabet, a backlight may transmit light within the second spectral range through the keys, causing the second set of filters to transmit light and the first set of filters to block light, displaying the characters or symbols in the second alphabet. In an example implementation, one or more sets of filters, or less than all of the keys within one set of filters, may transmit light within more than one spectral range and/or within a discontinuous spectral range, and the backlight may transmit light within one of the spectral ranges, or within a portion of discontinuous spectral range(s), through the filters of the keys. The computing system 100A may respond to a user depressing a key on the keyboard 108A by processing the character which is presented by the depressed key at the time the key is depressed.

FIG. 1B is a diagram of a computing system 100B according to another example embodiment. In this example, the computing system 100B, which may include a desktop computer, may include a keyboard 108B that is detached from a display 106B. A frame 103 may surround the display 106B. The frame 103 may also surround a processor and/or memory of the computing system 100B, or the processor and/or memory may be included in a separate device and may couple to, and/or communicate with, the display 106B via a wired or wireless interface.

The keyboard 108B may include any combination of features of the keyboard 108A discussed above with respect to FIG. 1A and/or discussed below with respect to subsequent figures. The keyboard 108B may couple to, and/or communicate with, the display 106B, processor, and/or memory, via a wired or wireless interface.

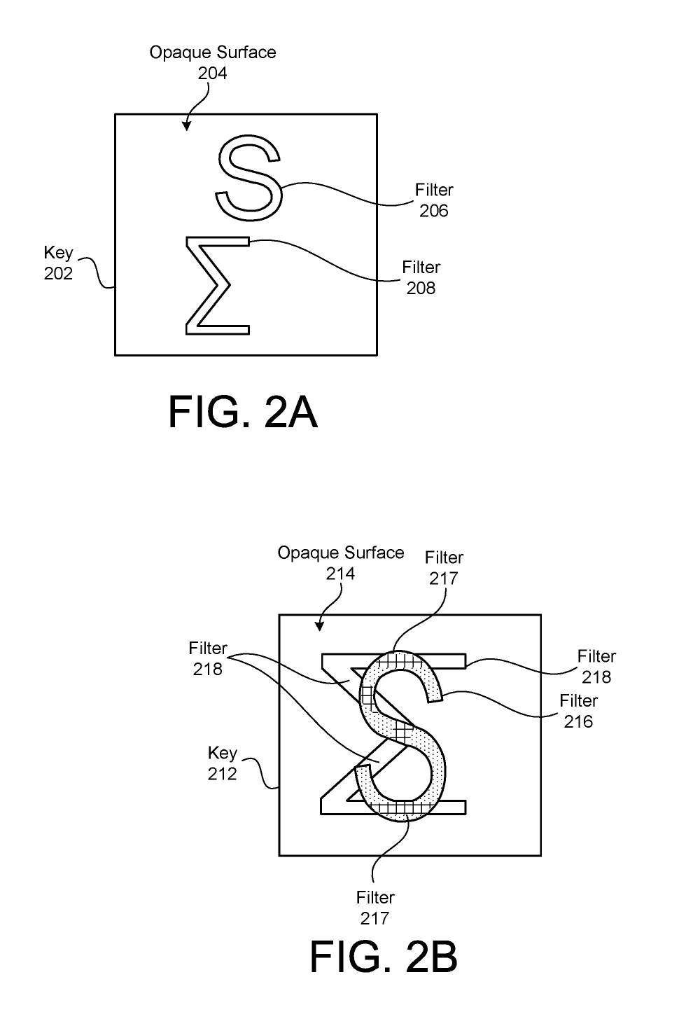

FIG. 2A is a top view of a key 202 included in a keyboard 108A, 108B of either of the computing systems 100A, 100B of FIGS. 1A and 1B according to an example embodiment. The key 202 may include a first filter 206 shaped according to, and/or in a shape of, a character or symbol in a first alphabet. In this example, the filter 206 is shaped according to the character of a capital ‘S’ in the English language. The first filter 206 may transmit light within a first spectral range, and block light outside the first spectral range. The key 202 may also include a second filter 208 shaped according to, and/or in a shape of, a character or symbol in a second alphabet. In this example, the filter 208 is shaped according to the character of a capital ‘Σ’ in ancient Greek. The second filter 208 may transmit light within a second spectral range, and block light outside the second spectral range. In an example embodiment, the first spectral range and the second spectral range may be non-overlapping, so that light transmitted by the first filter 206 is blocked by the second filter 208 and light transmitted by the second filter 208 is blocked by the first filter 206. This is merely an example, and filters in the shapes of many other characters or symbols may be included in the keys 202 on the keyboard 108A, 108B.

In the example shown in FIG. 2A, the first filter 206 and the second filter 208 are non-overlapping, so that no portion of a top surface of the key 202 includes portions of both the first filter 206 and the second filter 208. While two filters 206, 208 are shown in the key 202 of FIG. 2A, any number of filters corresponding to any number of alphabets may be included on the top surface of the key 202. In the example shown in FIG. 2A, portions of the top surface that are not included in the first filter 206 or the second filter 208 form an opaque surface 204 that blocks visible light of all wavelengths.

FIG. 2B is a top view of a key 212 included in a keyboard 108A, 108B of either of the computing systems 100A, 100B of FIGS. 1A and 1B according to another example embodiment. The key 212 may include a first filter 216 shaped according to, and/or in a shape of, a character or symbol in a first alphabet. In this example, the filter 201 is shaped according to the character of a capital ‘S’ in the English language. The first filter 216 may transmit light within a first spectral range, and block light outside the first spectral range. The key 212 may also include a second filter 218 shaped according to, and/or in a shape of, a character or symbol in a second alphabet. In this example, the filter 218 is shaped according to the character of a capital ‘Σ’ in ancient Greek. The second filter 218 may transmit light within a second spectral range, and block light outside the second spectral range. In an example embodiment, the first spectral range and the second spectral range may be non-overlapping, so that light transmitted by the first filter 216 is blocked by the second filter 218 and light transmitted by the second filter 218 is blocked by the first filter 216. While two example filters 216, 218 for two example characters are shown in FIG. 2B, more than two filters shaped according to more than two characters may be included in the key 212, according to example embodiments.

In the example shown in FIG. 2B, the first filter 216 and the second filter 218 are overlapping, forming an overlapping filter 217 (shown with a grid shading). The overlapping filter 217 may transmit light within both the first and second spectral ranges and block light outside the spectral ranges associated with the supported alphabets. While two filters 216, 218 are shown in the key 202 of FIG. 2B, any number of filters corresponding to any number of alphabets may be included on the top surface of the key 212, and overlapping filters may transmit light within a number of spectral ranges corresponding to the number of overlapping filters. In the example shown in FIG. 2B, portions of the top surface that are not included in the first filter 216, the second filter 218, or overlapping filter 217, form an opaque surface 214 that blocks visible light of all wavelengths.

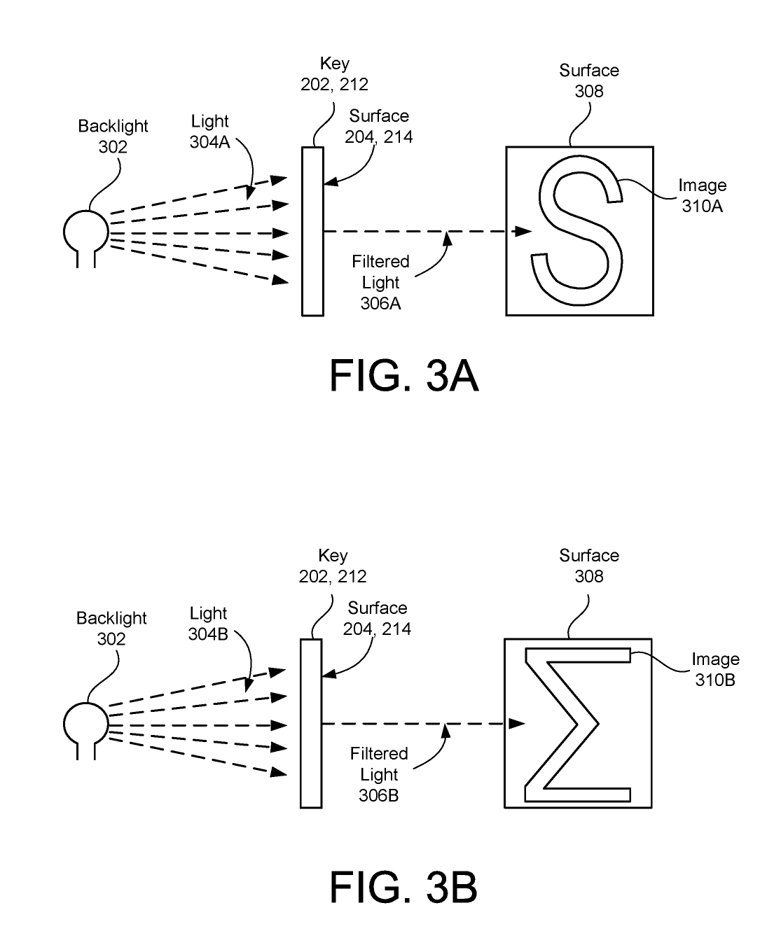

FIG. 3A shows a backlight 302 transmitting light 304A within the first spectral range through the first filter 206, 216 (shown in FIGS. 2A and 2B) of the key 202, 212 of either FIG. 2A or FIG. 2B according to an example embodiment. The backlight 302 may transmit light 304A with a wavelength within the first spectral range in response to an instruction from a processor of the computing system 100A, 100B to display or present the first alphabet. The light 304A may be of the first spectral range, causing portions of the light propagating to the first filter 206, 216 to be transmitted and portions of the light 304A propagating to the second filter 208, 218 or opaque surface 204, 214 to be blocked. Filtered light 306A may propagate away from the key 202, 212 and project a shape of the character or symbol within the first alphabet. For illustrative purposes, the filtered light 306A is shown in FIG. 3A as projecting onto a surface 308, forming an image 310A corresponding to the shape (capital ‘S’ in the English language) of the first filter 206, 216. In absence of a surface 308 onto which the filtered light 306A is projected, the filtered light 306A may cause the key 202, 212 to present the character or symbol within the first alphabet to an eye of the user. Filters in other keys within the keyboard 108A, 108B may also transmit images with shapes from the same, first alphabet, causing the symbols or characters within the first alphabet to be presented to the user.

FIG. 3B shows the backlight 302 transmitting light 304B within the second spectral range through the second filter 208, 218 of the key 202, 212 of either FIG. 2A or FIG. 2B according to an example embodiment. In this example, the light 304B may be of, and/or have a wavelength within, the second spectral range, causing portions of the light propagating to the second filter 208, 218 to be transmitted and portions of the light 304B propagating to the first filter 206, 218 or opaque surface 204, 214 to be blocked. The backlight 302 may transmit light 304B within the second spectral range in response to an instruction from a processor of the computing system 100A, 100B to display or present the second alphabet. Filtered light 306B may propagate away from the key 202, 212 and project a shape of the character or symbol within the second alphabet. For illustrative purposes, the filtered light 306B is shown in FIG. 3A as projecting onto a surface 308, forming an image 310B corresponding to the shape (capital ‘Σ’ in ancient Greek) of the second filter 208, 218. In absence of a surface 308 onto which the filtered light 306B is projected, the filtered light 306B may cause the key 202, 212 to present the character or symbol within the second alphabet to an eye of the user. Filters in other keys within the keyboard 108A, 108B may also transmit images with shapes from the same, second alphabet, causing the symbols or characters within the second alphabet to be presented to the user.

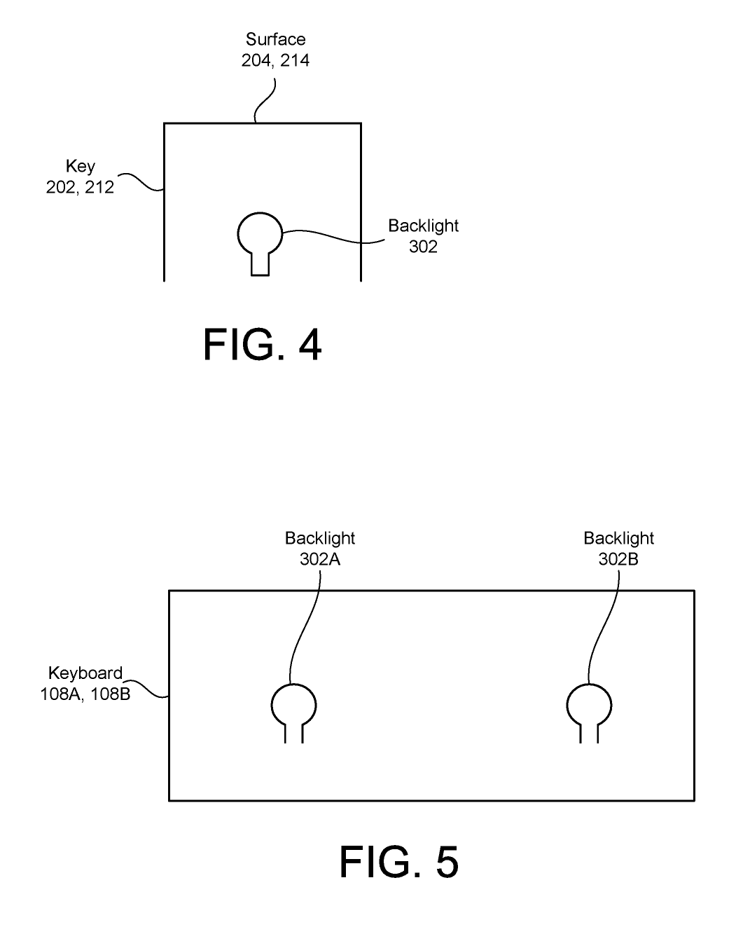

FIG. 4 is a diagram of the key 202, 212 in an example in which the backlight 302 is included in the key 202, 212. In this example, a backlight 302 is included in each key 202, 212 of the keyboard 108A, 108B. The backlight 302 may be disposed on a side of the key 202, 212 opposite from the surface 204, 214 and/or opposite from a direction in which the filters 206, 208, 216, 218 transmit light. The backlight 302 may include a light-emitting diode (LED). The backlight 302 of each key 202, 212 of the keyboard 108A, 108B may transmit light within a spectral range based on the alphabet that the user has selected and/or desires to type in.

FIG. 5 is a cross-sectional view of the keyboard 108A, 108B in an example in which the backlight 302A, 302B is disposed behind the keys 202, 212 (not shown in FIG. 5). In FIG. 5, the cross-sectional view is below the keys 202, 212. In this example, one or more, or multiple, backlights 302A, 302B may be shared by the keys 202, 212, and/or may each project light through multiple keys 202, 212. The backlight(s) 302A, 302B may transmit light to and/or through the keys 202, 212 within a spectral range associated with a language and/or alphabet that the user desires to type in. The backlight(s) 302A, 302B may include an LED(s).

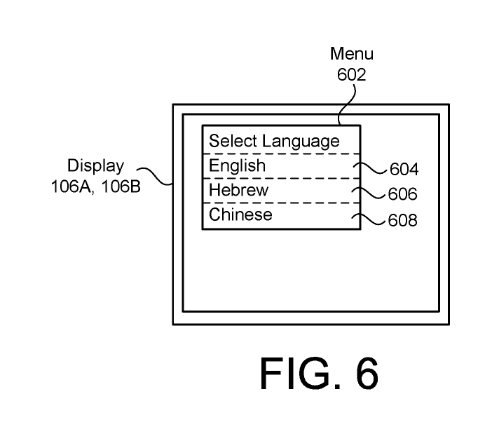

FIG. 6 shows a display 106A, 106B with a menu 602 for selecting a language according to an example embodiment. In this example, the display 106A, 106B may present a menu 602 within a graphical user interface (GUI) from which a user may select a language 604, 606, 608. The computing system 100A, 100B may generate the GUI to receive a selection of an alphabet from the user, based on which the computing system 100A, 100B may select a spectral range within which to transmit light through the key(s) 202, 212. In this example, the menu 602 from which the user selects a language 604, 606, 608 may include a drop-down menu. While this example shows a drop-down menu, the computing system 100A, 100B may present other interfaces for the user to select an alphabet and/or language within which the keys 202, 212 may present characters or symbols. The computing system 100A, 100B may present icons that the user may select, or the user may type a language or alphabet, as non-limiting examples. The computing system 100A, 100B may instruct the backlight(s) 302, 302A, 302B to transmit light in a spectral range associated with the selected language or alphabet.

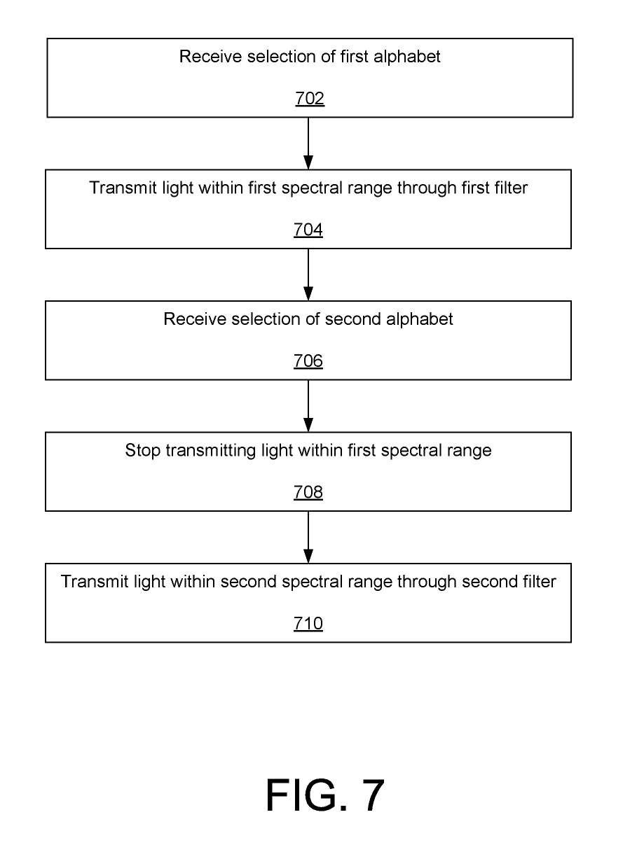

FIG. 7 is a flowchart showing a method according to an example embodiment. According to this example, the method may include receiving a selection of a first alphabet (702). The method may also include, based on the selection of the first alphabet, transmitting light within a first spectral range through a first filter within a key on a keyboard to display a first character (704). The method may also include receiving a selection of a second alphabet (706). The method may also include, based on the selection of the second alphabet, stopping transmission of the light within the first spectral range (708), and transmitting light within a second spectral range through a second filter within the key on the keyboard to display a second character (710).

According to an example, the first character may be a letter in a first language corresponding to the first alphabet, and the second character may be a letter in a second language corresponding to the second alphabet.

According to an example, the first spectral range and the second spectral range may be non-overlapping with each other.

According to an example, the first spectral range may be within a visible light spectrum and the second spectral range may be within the visible light spectrum.

According to an example, the first filter may block light within the second spectral range and the second filter may block light within the first spectral range.

According to an example, the first filter and the second filter may be non-overlapping.

According to an example, the first filter and the second filter may include at least one overlapping portion.

According to an example, the selection of the first alphabet and the second alphabet may be received via a graphical user interface (GUI).

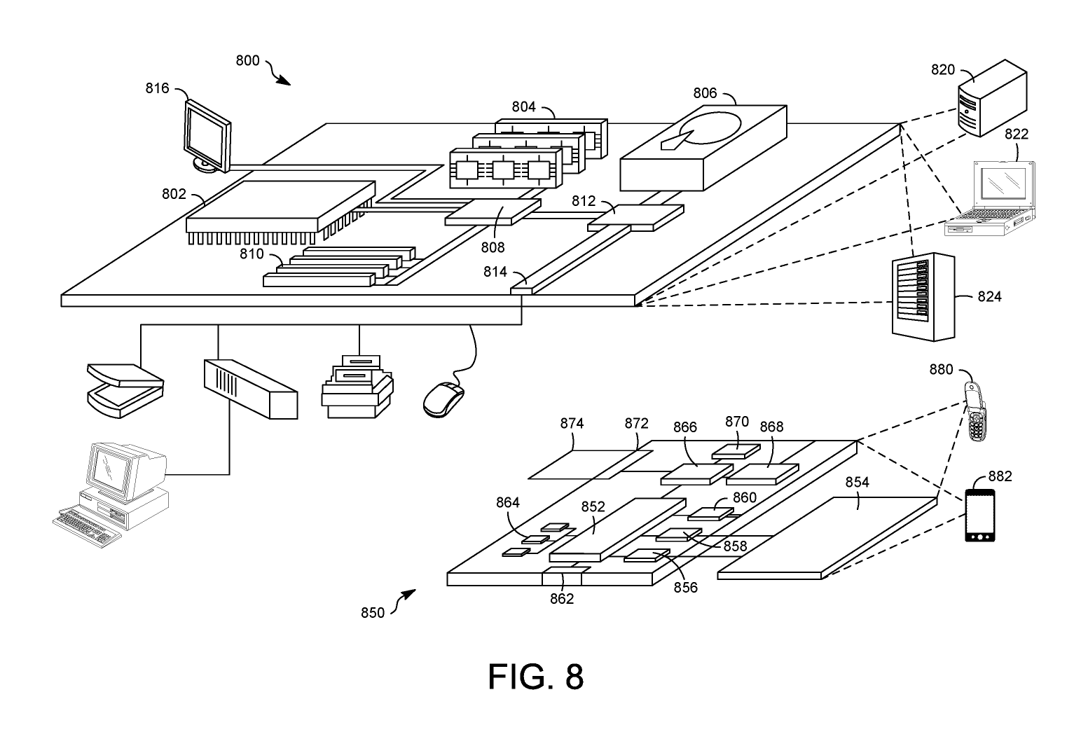

FIG. 8 shows an example of a generic computer device 800 and a generic mobile computer device 850, which may be used with the techniques described here. Computing device 800 is intended to represent various forms of digital computers, such as laptops, desktops, tablets, workstations, personal digital assistants, televisions, servers, blade servers, mainframes, and other appropriate computing devices. Computing device 850 is intended to represent various forms of mobile devices, such as personal digital assistants, cellular telephones, smart phones, and other similar computing devices. The components shown here, their connections and relationships, and their functions, are meant to be exemplary only, and are not meant to limit implementations of the inventions described and/or claimed in this document.

Computing device 800 includes a processor 802, memory 804, a storage device 806, a high-speed interface 808 connecting to memory 804 and high-speed expansion ports 810, and a low speed interface 812 connecting to low speed bus 814 and storage device 806. The processor 802 can be a semiconductor-based processor. The memory 804 can be a semiconductor-based memory. Each of the components 802, 804, 806, 808, 810, and 812, are interconnected using various busses, and may be mounted on a common motherboard or in other manners as appropriate. The processor 802 can process instructions for execution within the computing device 800, including instructions stored in the memory 804 or on the storage device 806 to display graphical information for a GUI on an external input/output device, such as display 816 coupled to high speed interface 808. In other implementations, multiple processors and/or multiple buses may be used, as appropriate, along with multiple memories and types of memory. Also, multiple computing devices 800 may be connected, with each device providing portions of the necessary operations (e.g., as a server bank, a group of blade servers, or a multi-processor system).

The memory 804 stores information within the computing device 800. In one implementation, the memory 804 is a volatile memory unit or units. In another implementation, the memory 804 is a non-volatile memory unit or units. The memory 804 may also be another form of computer-readable medium, such as a magnetic or optical disk.

The storage device 806 is capable of providing mass storage for the computing device 800. In one implementation, the storage device 806 may be or contain a computer-readable medium, such as a floppy disk device, a hard disk device, an optical disk device, or a tape device, a flash memory or other similar solid state memory device, or an array of devices, including devices in a storage area network or other configurations. A computer program product can be tangibly embodied in an information carrier. The computer program product may also contain instructions that, when executed, perform one or more methods, such as those described above. The information carrier is a computer- or machine-readable medium, such as the memory 804, the storage device 806, or memory on processor 802.

The high speed controller 808 manages bandwidth-intensive operations for the computing device 800, while the low speed controller 812 manages lower bandwidth-intensive operations. Such allocation of functions is exemplary only. In one implementation, the high-speed controller 808 is coupled to memory 804, display 816 (e.g., through a graphics processor or accelerator), and to high-speed expansion ports 810, which may accept various expansion cards (not shown). In the implementation, low-speed controller 812 is coupled to storage device 806 and low-speed expansion port 814. The low-speed expansion port, which may include various communication ports (e.g., USB, Bluetooth, Ethernet, wireless Ethernet) may be coupled to one or more input/output devices, such as a keyboard, a pointing device, a scanner, or a networking device such as a switch or router, e.g., through a network adapter.

The computing device 800 may be implemented in a number of different forms, as shown in the figure. For example, it may be implemented as a standard server 820, or multiple times in a group of such servers. It may also be implemented as part of a rack server system 824. In addition, it may be implemented in a personal computer such as a laptop computer 822. Alternatively, components from computing device 800 may be combined with other components in a mobile device (not shown), such as device 850. Each of such devices may contain one or more of computing device 800, 850, and an entire system may be made up of multiple computing devices 800, 850 communicating with each other.

Computing device 850 includes a processor 852, memory 864, an input/output device such as a display 854, a communication interface 866, and a transceiver 868, among other components. The device 850 may also be provided with a storage device, such as a microdrive or other device, to provide additional storage. Each of the components 850, 852, 864, 854, 866, and 868, are interconnected using various buses, and several of the components may be mounted on a common motherboard or in other manners as appropriate.

The processor 852 can execute instructions within the computing device 850, including instructions stored in the memory 864. The processor may be implemented as a chipset of chips that include separate and multiple analog and digital processors. The processor may provide, for example, for coordination of the other components of the device 850, such as control of user interfaces, applications run by device 850, and wireless communication by device 850.

Processor 852 may communicate with a user through control interface 858 and display interface 856 coupled to a display 854. The display 854 may be, for example, a TFT LCD (Thin-Film-Transistor Liquid Crystal Display) or an OLED (Organic Light Emitting Diode) display, or other appropriate display technology. The display interface 856 may comprise appropriate circuitry for driving the display 854 to present graphical and other information to a user. The control interface 858 may receive commands from a user and convert them for submission to the processor 852. In addition, an external interface 862 may be provide in communication with processor 852, so as to enable near area communication of device 850 with other devices. External interface 862 may provide, for example, for wired communication in some implementations, or for wireless communication in other implementations, and multiple interfaces may also be used.

The memory 864 stores information within the computing device 850. The memory 864 can be implemented as one or more of a computer-readable medium or media, a volatile memory unit or units, or a non-volatile memory unit or units. Expansion memory 874 may also be provided and connected to device 850 through expansion interface 872, which may include, for example, a SIMM (Single In Line Memory Module) card interface. Such expansion memory 874 may provide extra storage space for device 850, or may also store applications or other information for device 850. Specifically, expansion memory 874 may include instructions to carry out or supplement the processes described above, and may include secure information also. Thus, for example, expansion memory 874 may be provide as a security module for device 850, and may be programmed with instructions that permit secure use of device 850. In addition, secure applications may be provided via the SIMM cards, along with additional information, such as placing identifying information on the SIMM card in a non-hackable manner.

The memory may include, for example, flash memory and/or NVRAM memory, as discussed below. In one implementation, a computer program product is tangibly embodied in an information carrier. The computer program product contains instructions that, when executed, perform one or more methods, such as those described above. The information carrier is a computer- or machine-readable medium, such as the memory 864, expansion memory 874, or memory on processor 852, that may be received, for example, over transceiver 868 or external interface 862.

Device 850 may communicate wirelessly through communication interface 866, which may include digital signal processing circuitry where necessary. Communication interface 866 may provide for communications under various modes or protocols, such as GSM voice calls, SMS, EMS, or MMS messaging, CDMA, TDMA, PDC, WCDMA, CDMA2000, or GPRS, among others. Such communication may occur, for example, through radio-frequency transceiver 868. In addition, short-range communication may occur, such as using a Bluetooth, WiFi, or other such transceiver (not shown). In addition, GPS (Global Positioning System) receiver module 870 may provide additional navigation- and location-related wireless data to device 850, which may be used as appropriate by applications running on device 850.

Device 850 may also communicate audibly using audio codec 860, which may receive spoken information from a user and convert it to usable digital information. Audio codec 860 may likewise generate audible sound for a user, such as through a speaker, e.g., in a handset of device 850. Such sound may include sound from voice telephone calls, may include recorded sound (e.g., voice messages, music files, etc.) and may also include sound generated by applications operating on device 850.

The computing device 850 may be implemented in a number of different forms, as shown in the figure. For example, it may be implemented as a cellular telephone 880. It may also be implemented as part of a smart phone 882, personal digital assistant, or other similar mobile device.

Various implementations of the systems and techniques described here can be realized in digital electronic circuitry, integrated circuitry, specially designed ASICs (application specific integrated circuits), computer hardware, firmware, software, and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

These computer programs (also known as programs, software, software applications or code) include machine instructions for a programmable processor, and can be implemented in a high-level procedural and/or object-oriented programming language, and/or in assembly/machine language. As used herein, the terms “machine-readable medium” “computer-readable medium” refers to any computer program product, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term “machine-readable signal” refers to any signal used to provide machine instructions and/or data to a programmable processor.

To provide for interaction with a user, the systems and techniques described here can be implemented on a computer having a display device (e.g., a CRT (cathode ray tube) or LCD (liquid crystal display) monitor) for displaying information to the user and a keyboard and a pointing device (e.g., a mouse or a trackball) by which the user can provide input to the computer. Other kinds of devices can be used to provide for interaction with a user as well; for example, feedback provided to the user can be any form of sensory feedback (e.g., visual feedback, auditory feedback, or tactile feedback); and input from the user can be received in any form, including acoustic, speech, or tactile input.

The systems and techniques described here can be implemented in a computing system that includes a back end component (e.g., as a data server), or that includes a middleware component (e.g., an application server), or that includes a front end component (e.g., a client computer having a graphical user interface or a Web browser through which a user can interact with an implementation of the systems and techniques described here), or any combination of such back end, middleware, or front end components. The components of the system can be interconnected by any form or medium of digital data communication (e.g., a communication network). Examples of communication networks include a local area network (“LAN”), a wide area network (“WAN”), and the Internet.

The computing system can include clients and servers. A client and server are generally remote from each other and typically interact through a communication network. The relationship of client and server arises by virtue of computer programs running on the respective computers and having a client-server relationship to each other.

A number of embodiments have been described. Nevertheless, it will be understood that various modifications may be made without departing from the spirit and scope of the invention.

In addition, the logic flows depicted in the figures do not require the particular order shown, or sequential order, to achieve desirable results. In addition, other steps may be provided, or steps may be eliminated, from the described flows, and other components may be added to, or removed from, the described systems. Accordingly, other embodiments are within the scope of the following claims.

What is claimed is:

1. A computing system comprising:
a keyboard comprising at least one key, the at least one key including:
a first filter shaped according to a first character in a first alphabet, the first filter transmitting light within a first spectral range; and
a second filter shaped according to a second character in a second alphabet, the second filter transmitting light within a second spectral range; and
at least one backlight configured to:
shine light of a first wavelength within the first spectral range in response to an instruction to display the first alphabet; and
shine light of a second wavelength within the second spectral range in response to an instruction to display the second alphabet.

2. The computing system of claim 1, wherein:
the first character is a letter in a first language corresponding to the first alphabet; and
the second character is a letter in a second language corresponding to the second alphabet.

3. The computing system of claim 1, wherein the first character is an emoticon.

4. The computing system of claim 1, wherein the first spectral range and the second spectral range are non-overlapping with each other.

5. The computing system of claim 1, wherein the first spectral range is within a visible light spectrum and the second spectral range is within the visible light spectrum.

6. The computing system of claim 1, wherein the first filter blocks light within the second spectral range and the second filter blocks light within the first spectral range.

7. The computing system of claim 1, wherein the first filter and the second filter are non-overlapping.

8. The computing system of claim 1, wherein the first filter and the second filter include at least one overlapping portion.

9. The computing system of claim 1, wherein the at least one backlight comprises no more than one light-emitting diode (LED) per key on the keyboard.

10. The computing system of claim 1, wherein the at least one backlight is disposed on a side of the at least one key opposite from a direction in which the first filter and the second filter transmit the light.

11. The computing system of claim 1, further comprising a processor configured to send, to the at least one backlight, the instruction to display the first alphabet and the instruction to display the second alphabet.

12. A method comprising:
receiving a selection of a first alphabet;
based on the selection of the first alphabet, transmitting light within a first spectral range through a first filter within a key on a keyboard to display a first character;
receiving a selection of a second alphabet;
based on the selection of the second alphabet:
stopping transmission of the light within the first spectral range; and
transmitting light within a second spectral range through a second filter within the key on the keyboard to display a second character.

13. The method of claim 12, wherein:
the first character is a letter in a first language corresponding to the first alphabet; and
the second character is a letter in a second language corresponding to the second alphabet.

14. The method of claim 12, wherein the first spectral range and the second spectral range are non-overlapping with each other.

15. The method of claim 12, wherein the first spectral range is within a visible light spectrum and the second spectral range is within the visible light spectrum.

16. The method of claim 12, wherein the first filter blocks light within the second spectral range and the second filter blocks light within the first spectral range.

17. The method of claim 12, wherein the first filter and the second filter are non-overlapping.

18. The method of claim 12, wherein the first filter and the second filter include at least one overlapping portion.

19. The method of claim 12, wherein the selection of the first alphabet and the second alphabet are received via a graphical user interface (GUI).

20. A key for a keyboard of a computing system, the key comprising:
a first filter shaped according to a first character in a first alphabet, the first filter transmitting light within a first spectral range; and
a second filter shaped according to a second character in a second alphabet, the second filter transmitting light within a second spectral range.
